(19) United States
(12) Patent Application Publication
(10) Pub. No.: US 2013/0195283 A1
(43) Pub. Date: Aug. 1, 2013

(54) TIP-RING-RING-SLEEVE PUSH-TO-TALK SYSTEM AND METHODS

(71) Applicants: David Larson, Seattle, WA (US); Paul Peavyhouse, Bothell, WA (US)

(72) Inventors: David Larson, Seattle, WA (US); Paul Peavyhouse, Bothell, WA (US)

(73) Assignee: TWISTED PAIR SOLUTIONS, INC., Seattle, WA (US)

(21) Appl. No.: 13/364,161

(22) Filed: Feb. 1, 2012

(51) Int. Cl. H04R 1/10; H04R 3/00

(52) U.S. Cl. 381/74; 381/111

(57) ABSTRACT

Push-to-talk audio devices and methods are provided. The audio device can include a tip-ring-ring-sleeve connector having a sleeve, tip, first ring, and second ring that are electrically isolated from each other. A microphone and a push-to-talk switch selectively operable to provide an electrical short across the microphone in a first state and to remove the electrical short from across the microphone in a second state are electrically coupled between the sleeve and the second ring.

### BACKGROUND

1. Technical Field

This disclosure generally relates to combination headsets containing speakers and microphones.

2. Description of the Related Art

Over a relatively short period of time, the cellular telephone has grown from a dedicated communication device to a multipurpose device having a surprising number of functions controlled using an architecture and processor closely resembling a dedicated computing device—giving birth to the term “smartphone.” Current smartphones have either a tip-ring-sleeve (referred to as a “TRS” jack) or a tip-ring-ring-sleeve (referred to as a “TRRS” jack) to accommodate audio input and/or audio output using external devices other than the speaker(s) and microphone(s) integrated into the smartphone package. These TRS and TRRS jacks are generally provided as either a 2.5 mm diameter or a 3.5 mm diameter female jack on an exterior surface of the smartphone.

Although the TRRS jack is intended to provide two speaker circuits and one microphone circuit, additional functionality may be gleaned from the jack by configuring the smartphone hardware or operating system to recognize various signals transmitted to the operating system via the TRRS jack. Such hardware or operating system modifications are frequently device or platform specific and are somewhat limited in applicability by the sheer number and variety of smartphones on the market.

One popular smartphone feature is push-to-talk functionality. When using a push-to-talk mode, the smartphone user provides an input to the smartphone to enter transmit or broadcast mode where the microphone is enabled. Similarly, the user provides a second input to the smartphone indicating the termination of transmit or broadcast mode, such as commonly encountered in the use of conventional walkie-talkies. Push-to-talk functionality may be provided by adding conductors to the traditional tip-ring-ring-sleeve connector (e.g. a tip-ring-ring-ring-sleeve or TRRRS jack). The added conductors provide one or more additional signal paths to the smartphone, which when coupled with appropriate changes to the smartphone operating system or software may be used to enter and exit a push-to-talk mode. Push-to-talk functionality may also be provided using one or more signals, for example a first signal to enter push-to-talk mode and a second signal to exit push-to-talk mode. With push-to-talk functionality, a user is able to selectively engage another user in conversation. Thus, hardware providing push-to-talk functionality while minimizing or eliminating the need to modify either the hardware or operating system of the host smartphone is desirable.

### BRIEF SUMMARY

An audio device may be summarized as including a connector including a tip, a first ring, a second ring, and a sleeve, the tip, the first ring, the second ring, and the sleeve are each electrically conductive and electrically isolated from one another; a microphone electrically coupled between the sleeve and the second ring; and a push-to-talk switch electrically coupled between the sleeve and the second ring, the push-to-talk switch selectively operable to provide a low impedance electrical connection across the microphone in a first state and to remove the low impedance electrical connection from across the microphone in a second state.

The device may further include a first speaker electrically coupled between the tip and the second ring; and a second speaker electrically coupled between the first ring and the second ring. The first and the second speakers may be part of a headset. The push-to-talk switch may include at least one set of momentary, normally closed, contacts. The push-to-talk switch may be biased to the first state.

The device may further include a mechanical lock selectively operable to retain the push-to-talk switch in the second state.

The device may further include a first adjustment mechanism including a first switch and a first resistor having a first resistance, the first switch having at least a first state and a second state and selectively operable to remove the low impedance electrical connection across the microphone via the first resistor in the second state of the first switch.

The device may further include a second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch. When in the respective first states, the first and the second switches may provide the low impedance electrical connection across the microphone along with the push-to-talk switch. The first and the second switches may be biased to the first state. The connector may include either a 3.5 mm diameter tip-ring-ring-sleeve connector or a 2.5 mm diameter tip-ring-ring-sleeve connector.

The device may further include a switch to open the low impedance electrical connection across the microphone when the push-to-talk switch is in the first state.

An audio device may be summarized as including a connector including a tip, a first ring, a second ring, and a sleeve, the tip, the first ring, the second ring, and the sleeve are each electrically conductive and electrically isolated from one another; a first speaker electrically coupled between the tip and the second ring; a second speaker electrically coupled between the first ring and the second ring; a housing at least partially enclosing a microphone electrically coupled between the sleeve and the second ring and at least partially enclosing a push-to-talk switch electrically coupled between the sleeve and the second ring; the push-to-talk switch selectively operable to provide a low impedance electrical connection across the microphone in a first state and to remove the low impedance electrical connection from across the microphone in a second state. The push-to-talk switch may be biased to the first state.

The device may further include a mechanical lock proximate the housing, the mechanical lock selectively operable to retain the push-to-talk switch in the second state.

The device may further include a first adjustment mechanism disposed at least partially within the housing, the first adjustment mechanism including a first switch and a first resistor having a first resistance, the first switch having at least a first state and a second state and selectively operable to remove the low impedance electrical connection across the microphone via the first resistor in the second state of the first switch.

The device may further include a second adjustment mechanism disposed at least partially within the housing, the second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch. In the respective first states, the first and the second switches may provide the low impedance electrical connection across the microphone along with the push-to-talk switch.

An audio method may be summarized as including coupling a microphone between a sleeve and a second ring of a tip-ring-ring-sleeve connector to provide an audio input circuit; and coupling push-to-talk switch between the sleeve and the second ring, the push-to-talk switch selectively operable to provide a low impedance electrical connection across the microphone in a first state and to remove the low impedance electrical connection from across the microphone in a second state.

The method may further include coupling a first adjustment mechanism around the push-to-talk switch, the first adjustment mechanism including a first switch and a first resistor having a first resistance, the first switch having at least a first state and a second state and selectively operable to remove the low impedance electrical connection across the microphone via the first resistor in the second state of the first switch; and coupling a second adjustment mechanism around the push-to-talk switch, the second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch.

### BRIEF DESCRIPTION OF THE SEVERAL VIEWS OF THE DRAWINGS

In the drawings, identical reference numbers identify similar elements or acts. The sizes and relative states of elements in the drawings are not necessarily drawn to scale. For example, the positions of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a schematic diagram of a push-to-talk headset system including a momentary, normally-closed, switch, according to one illustrated embodiment.

FIG. 1B is a schematic diagram of a push-to-talk headset system including a momentary, normally-closed, switch, and a maintained contact bypass switch, according to one illustrated embodiment.

FIG. 1C is a schematic diagram of a push-to-talk headset system including a momentary, normally-closed, switch, and a mechanical locking mechanism, according to one illustrated embodiment.

FIG. 2 is a schematic diagram of a push-to-talk headset system including a momentary, normally-closed, switch, a step up circuit and a step down circuit, according to one illustrated embodiment.

FIG. 3 is a schematic diagram of a push-to-talk headset system including a momentary, normally-closed, switch and microphone disposed within a housing, according to one illustrated embodiment.

FIG. 4 is a schematic diagram of a push-to-talk headset system including a momentary, normally-closed, switch, a step up circuit, a step down circuit, and a microphone disposed within a housing, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communication devices such as cellular phones, smartphones, and/or radios have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Although the push-to-talk functionality is described herein with respect to a representative tip-ring-ring-sleeve configuration, it is readily appreciated by one of ordinary skill in the art that similar configurations of a tip-ring-ring-sleeve connector may be substituted to achieve a similar result.

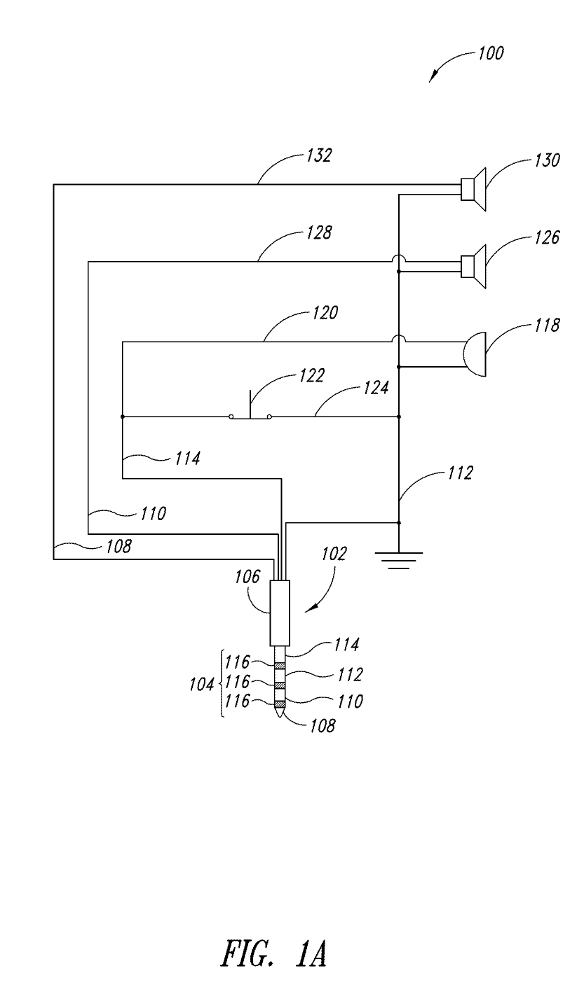

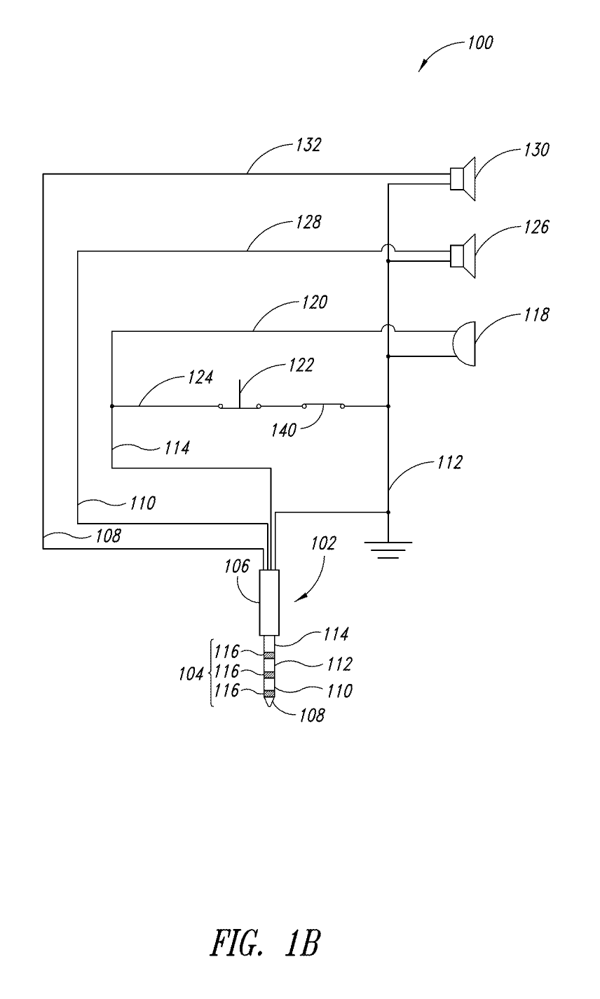

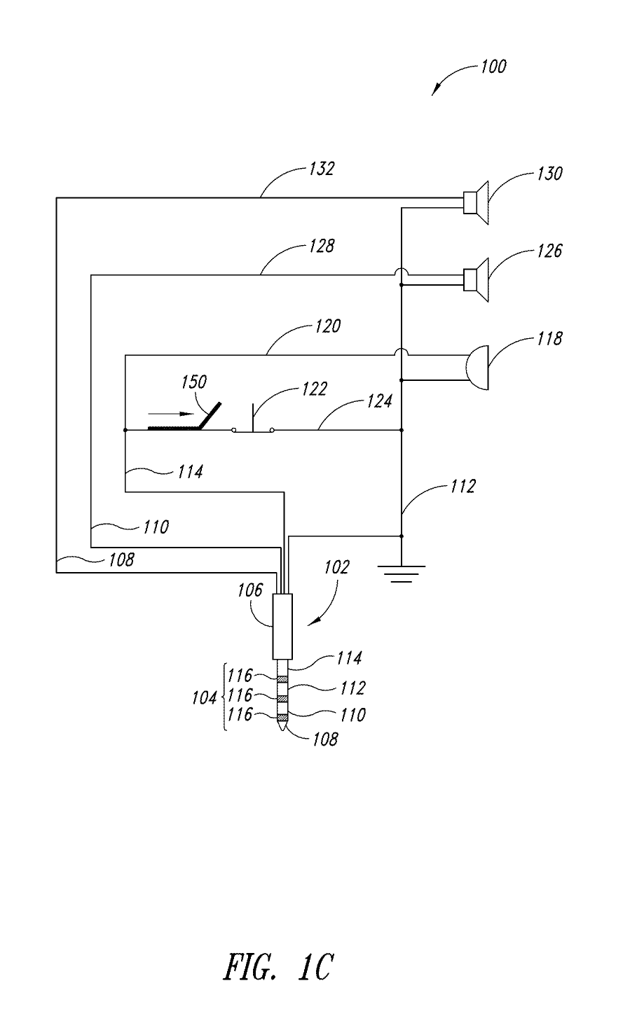

FIG. 1 depicts a tip-ring-ring-sleeve connector 102 coupled to a microphone 118, a push-to-talk switch 122, a first speaker 126 and a second speaker 130. The tip-ring-ring-sleeve connector 102 includes a conductive, cylindrical shaped, segmented, shaft 104 extending from a larger, non-conductive, body 106 facilitating manipulation of the connector 102 by a user. The tip-ring-ring-sleeve connector 102 obtains its name from the structure of the conductive shaft 104 which contains a tip 108, a first ring 110, a second ring 112, and a sleeve 114. The tip 108, the first ring 110, the second ring 112, and the sleeve 114 are electrically conductive and are electrically coupled to the respectively numbered and named tip 108 conductor, first ring 110 conductor, second ring 112 conductor, and sleeve 114 conductor. To electrically isolate the tip 108 conductor, first ring 110 conductor, second ring 112 conductor, and sleeve 114 conductor from each other, isolators 116 are disposed between the tip 108, the first ring 110, the second ring 112, and the sleeve 114 on the tip-ring-ring-sleeve connector 102.

The shaft 104 of the tip-ring-ring-sleeve connector 102 can be of any available dimension, with diameters of 3.5 mm (approx. ⅛″) and 2.5 mm (approx. 3/32″) being used for many compact electrical devices such as smartphones. In some instances, larger shafts, for example a ¼″ diameter shaft, may also be used. Each of the tip 108, first ring 110, second ring 112 and sleeve 114 is formed of an electrically conductive material, brass and aluminum being but two of many example conductive materials amenable for use as a tip-ring-ring-sleeve connector 102. Electrically non-conductive materials (i.e., insulators) are disposed to electrically isolate the tip 108, the first ring 110, the second ring 112 and the sleeve 114 from each other.

A push-to-talk circuit 124 including the push-to-talk switch 122 is depicted as electrically in parallel with the microphone circuit 120 which includes the microphone 118. The microphone circuit 120 and the push-to-talk circuit 124 electrically couple the second ring 112 to the sleeve 114 of the tip-ring-ring-sleeve connector 102. The push-to-talk switch 122 may take the form of a momentary, normally-closed, switch that is selectively configurable into at least a first state and a second state. When in the first state, the push-to-talk switch 122 closes the push-to-talk circuit 124 providing a low impedance electrical connection around the microphone circuit 120. When in the second state, the push-to-talk switch 122 opens the push-to-talk circuit 124 removing the low impedance electrical connection around the microphone circuit 120. In one or more embodiments, the push-to-talk circuit 124 can be a connection having minimal or no impedance, i.e. a short circuit.

The push-to-talk switch 122 may be configurable mechanically, electrically, or electro-mechanically in either the first state or the second state in response to user actuation (e.g., a push). The push-to-talk switch 122 provides an electrically continuous path when in the first state, and an electrically non-continuous path when in the second state. While the push-to-talk switch 122 is generally described herein in terms of a mechanical switch for clarity, conciseness and brevity, it is understood that electro-mechanical and electrical switches such as capacitive and resistive switches may also be used to provide the push-to-talk switch 122. Although depicted as having only a single set of normally closed contacts, additional normally open or normally closed contacts may be added to or otherwise incorporated within the push-to-talk switch 122 to provide additional features or functionality.

In operation, the push-to-talk switch 122 forms a portion of the push-to-talk circuit 124 selectively bypassing the microphone 118. The low impedance electrical connection formed by the push-to-talk circuit 124 about the microphone 118 prevents the communication of signals generated by the microphone 118, for example the electric signal generated using a piezoelectric element or electret disposed at least partially within the microphone 118, to the sleeve 114 portion of the tip-ring-ring-sleeve connector 102. When in the first (i.e., closed) state, the presence of the push-to-talk switch 122 effectively prevents the communication of an audio input signal generated by the microphone 118. The state of the push-to-talk switch 122 does not affect or otherwise impact the transmission of audio signals to the first and second speakers 126, 130 via the first speaker circuit 128 and the second speaker circuit 132, thus full-duplex operation of the headset 100 is maintained, regardless of the state, or even the presence, of the push-to-talk switch 122.

In the absence of user intervention or actuation, the push-to-talk switch 122 is mechanically, electrically, or electromechanically maintained in the normally closed state depicted in FIG. 1. User intervention or actuation, for example pressing a mechanical push-to-talk switch 122 or touching (e.g., placing a finger on) a capacitive push-to-talk switch 122 can operatively place the push-to-talk switch 122 to the second state. By operatively placing the push-to-talk switch 122 to the second state, the push-to-talk circuit 124 is opened and the microphone circuit 120 becomes the only circuit electrically coupling the sleeve 114 to the second ring 112. While the push-to-talk switch is in the second state, electrical signals generated by the microphone 118, for example analog or digital electrical signals generated by an audio input to the microphone, can be communicated to the tip-ring-ring-sleeve connector 102 and to an attached electronic device.

In some embodiments, the user can maintain the push-to-talk switch 122 in the second state (i.e., open position) while speaking into the microphone 118 and can return the push-to-talk switch 122 to the first state (i.e., closed position) when not speaking into the microphone 118. Such operative placement of the push-to-talk switch 124 permits the communication of audio input to the tip-ring-ring-sleeve connector 102 only when the user affirmatively places the push-to-talk switch 122 to the second state. Advantageously, the creation of the push-to-talk circuit does not require hardware, software, device driver, or operating system modifications to or the installation of additional software or device drivers on the host electronic device coupled to the headset 100 to implement push-to-talk functionality on the device. Instead, existing media button events already present and handled by the smartphone operating system may be used to implement push-to-talk functionality.

When the push-to-talk switch 122 is in the first (i.e. closed) state, the push-to-talk circuit 124 provides a low impedance electrical connection between the second ring 112 and the sleeve 114. The low impedance electrical connection between the second ring 112 and the sleeve 114 provided by the push-to-talk circuit 124 can result in a continuous current draw that will increase the discharge rate of a battery powered electronic device coupled to the headset 100. Measured current drain attributable to the low impedance electrical connection provided by the push-to-talk circuit 124 can depend upon many factors including the battery type, battery age, and specific electronic device construction, mechanical, and operating system parameters, however a current drain of about 0.5 mA has been observed. To mitigate the impact of the current drain attributable to the push-to-talk circuit 124, in some embodiments a maintained contact switch 140 can be disposed within the push-to-talk circuit 124 as depicted in FIG. 1B. The maintained contact switch 140 can be selectively operated or actuated by the user to open the push-to-talk circuit 124 thereby eliminating the current draw attributable to the push-to-talk circuit 124, disabling the push-to-talk capability of the headset, and enabling the microphone circuit 120. When opened, the presence of the maintained contact switch 140 within the push-to-talk circuit 124 converts the headset 100 into a non-push-to-talk headset. By closing the maintained contact switch 140, the push-to-talk circuit 124 and headset push-to-talk functionality are restored.

Although illustratively described above in the context of a battery powered portable device, embodiments incorporating one or more electro-mechanical relays or solid state control circuits may also be implemented. Such implementations may be powered using the smartphone internal battery, the smartphone external power supply, power supplied via an external source, or any combination thereof.

As depicted in FIG. 1C in at least some embodiments a mechanical lock 150 is selectively operable to retain the push-to-talk switch 122 in the second state (i.e., the open position interrupting the push-to-talk circuit 124 and enabling push-to-talk mode). The use of the mechanical lock 150 to maintain the push-to-talk switch 122 in the second state frees the user of the requirement to hold the push-to-talk switch 122 in the second state while in push-to-talk mode. The mechanical lock can take any of a large variety of forms, for example a detent mechanism. In at least some embodiments, the mechanical lock 150 places the headset in a “normal” communication mode whereby full duplex operation of the speakers and microphone is provided.

The tip-ring-ring-sleeve connector 102 provides two independent circuits for audio output. Connection of a first speaker 126 to a first output circuit 128 electrically coupling the first ring 110 to the second ring 112 can provide a first independent audio channel. Connection of a second speaker 130 to a second output circuit 132 electrically coupling the tip 108 to the second ring 112 can provide a second independent audio channel. The first and second independent audio channels may be useful in providing two independent audio output streams, or may be useful in proving a two-channel stereo output to the first and second speakers. It is also possible to change a stereo tip-ring-ring-sleeve headset (i.e. a headset having independent audio output circuits 128 and 132 to the first and second speakers 126 and 130, respectively) to a monaural tip-ring-sleeve headset (i.e. a headset having a single common audio output circuit to the first and second speakers 126 and 130). In at least some instances, the first and second speakers 126, 130 form at least a portion of a headset and are disposed within a flexible or rigid headset structure adapted to be worn on or about a user's head with the first and second speakers 126 and 130 disposed proximate a user's ears and the microphone 118 disposed proximate the user's mouth.

The push-to-talk circuit 124 may, in some embodiments, also serve as an input to an electronic device coupled to the headset 100. For example, on an electronic device running the Android® operating system, the opening of the push-to-talk switch 122 can be detected and the operating system can provide, for example, a “Finish:long click (center)” event notification. Upon generation, the “Finish:long click (center)” event notification can be used, for example, to execute one or more operating system functions or software applications, for example opening a predetermined or preselected channel and initiating transmission of one or more audio input signals on the channel. Similarly, release of the push-to-talk switch 122 can be detected and the operating system can provide, for example, a “Start:long click (center)” event notification. Upon generation, the “Start:long click (center)” event notification can be used, for example, to execute one or more operating system functions or software applications, for example, to close the predetermined or preselected channel and terminate the transmission of one or more audio input signals provided by the microphone 118 on the channel.

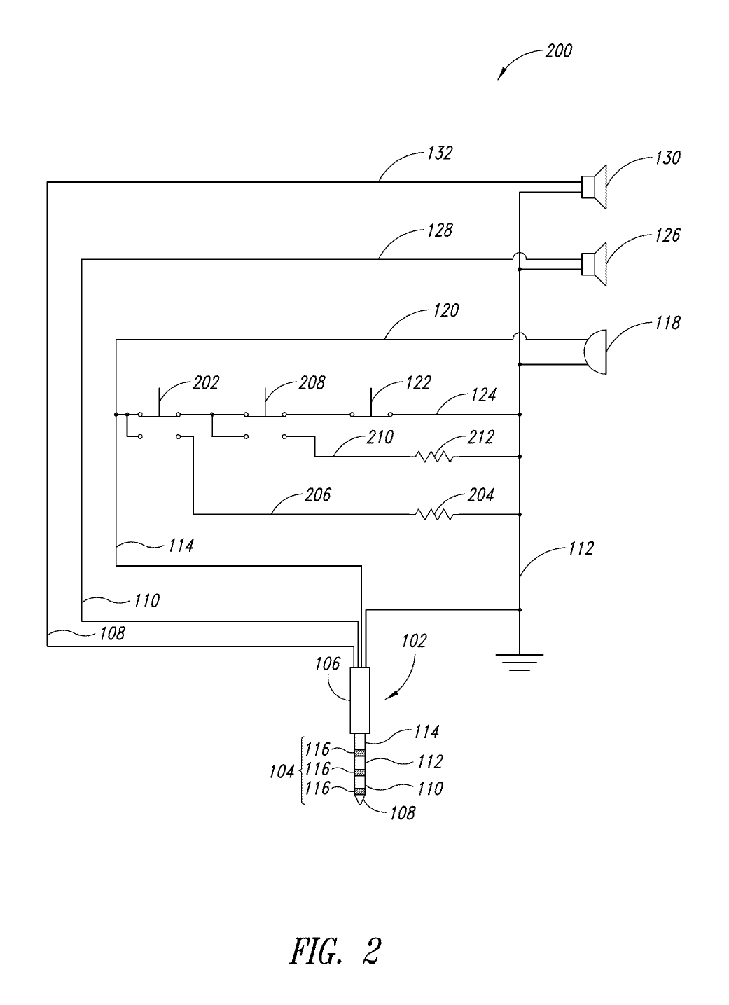

FIG. 2 depicts a tip-ring-ring-sleeve connector 102 coupled to a microphone 118, a push-to-talk switch 122, a first speaker 126 and a second speaker 130. In addition to the push-to-talk circuit 124 discussed above in regard to FIG. 1A, a first adjustment mechanism and a second adjustment mechanism are provided in the headset 200 depicted in FIG. 2. The first adjustment mechanism couples the push-to-talk circuit 124 to the second ring 112 and includes a first circuit 206 incorporating a first switch 202 and a first resistor 204 having a first resistance. The second adjustment mechanism couples the push-to-talk circuit 124 to the second ring 112 and includes a circuit 210 incorporating a second switch 208 and a second resistor 212 having a second resistance.

The first switch 202 may take the form of a momentary switch having at least one set of normally closed contacts and at least one set of normally open contacts. The at least one set of normally closed contacts on the first switch 202, the second switch 208, and the push-to-talk switch 122 are electrically coupled in series to form at least a portion of the push-to-talk circuit 124. The first switch 202 can be placed in at least two operating states: a first state where the at least one set of normally closed contacts complete the push-to-talk circuit 124 and the at least one set of normally open contacts opens to interrupt the first circuit 206; and a second state where the at least one set of normally closed contacts opens to interrupt the push-to-talk circuit 124 and the normally open contacts close to complete the first circuit 206. When completed, the first circuit 206 places the first resistor 204 electrically parallel with the microphone circuit 120.

Similarly, the second switch 208 may also take the form of a momentary switch having at least one set of normally closed contacts and at least one set of normally open contacts. The at least one set of normally closed contacts on the second switch 208, the first switch 202, and the push-to-talk switch 122 are electrically coupled in series to form at least a portion of the push-to-talk circuit 124. The second switch 208 can be placed in at least two operating states: a first state where the at least one set of normally closed contacts complete the push-to-talk circuit 124 and the at least one set of normally open contacts opens to interrupt the second circuit 210; and a second state where the at least one set of normally closed contacts opens to interrupt the push-to-talk circuit 124 and the normally open contacts close to complete the second circuit 210. When completed, the second circuit 210 places the second resistor 212 in parallel with the microphone circuit 120.

Together, the normally closed contacts on the first switch 202, the second switch 208, and the push-to-talk switch 122 are electrically coupled in series to form an electrically continuous push-to-talk circuit 124 when all three switches 202, 208, 122 are in the respective first state (i.e., when the at least one set of normally closed contacts in all three of the switches are CLOSED). Being electrically coupled in series, placement of any one of the three switches 202, 208, 122 from the first state to the second state (i.e. when at least one the at least one set of normally closed contacts in any of the three switches are OPEN) is sufficient to interrupt electrical continuity through the push-to-talk circuit 124.

Recall the tip-ring-ring-sleeve connector 102 on the headset 200 can be detachably coupled to a jack of an electronic device executing an operating system and/or software. When the first switch 202 is placed in the second state, the first circuit 206 including the first resistor 204 is placed electrically in parallel with the microphone circuit 120. The operating system or software executing on the electronic device can detect the first resistor 204 being placed electrically in parallel with the microphone circuit 120. Since the first resistance of the first resistor 204 is uniquely identifiable, the operating system or software executed on the electronic device can determine that the first switch 202 has been placed in the second state. Responsive to the detection of the first switch 202 being placed in the second state, the operating system or software executing on the electronic device can implement one or more functions, such as stepping through a command menu or scrolling through a series of predetermined or preselected communications channels in a first direction.

In a similar manner, when the second switch 208 is placed in the second state, the second circuit 210 including the second resistor 212 is placed electrically in parallel with the microphone circuit 120. The operating system or software executing on the electronic device can detect the second resistor 212 being placed in parallel with the microphone circuit 120. Since the second resistance of the second resistor 212 is uniquely identifiable, the operating system or software executing on the electronic device can determine that the second switch 208 has been placed in the second state. Responsive to the detection of the second switch 208 being placed in the second state, the operating system or software executing on the electronic device can implement one or more functions, such as stepping through a command menu or scrolling through a series of predetermined or preselected communications channels in a second direction.

The difference between the first resistance and the second resistance distinguishes the first resistor 204 from the second resistor 212. The specific values of the first resistance and the second resistance need only be different, known, values in order to distinguish the first circuit 206 and the second circuit 210 to the operating system or software executing on the electronic device. Example, non-limiting resistance values are a first resistance of about 220 ohms for the first resistor 204 and a second resistance of about 600 ohms for the second resistor 212. Different first and second resistances permit the operating system and/or software executing on the electronic device to accurately determine the states and/or positions of the push-to-talk switch 122, the first switch 202, and the second switch 208.

The first circuit 206 and the second circuit 210 are disposed electrically in parallel with the push-to-talk circuit 124 and are not electrically coupled to the first speaker circuit 128 or the second speaker circuit 132. As such, audio signals transmitted to the first and second speakers 126, 130 via the first speaker circuit 128 and the second speaker circuit 132 are unaffected by the state of the push-to-talk switch 122, the first switch 202, or the second switch 208. Thus the headset 200 retains full-duplex capabilities at all times, regardless of the state, or even the presence, of the push-to-talk switch 122, the first switch 202, and the second switch 208.

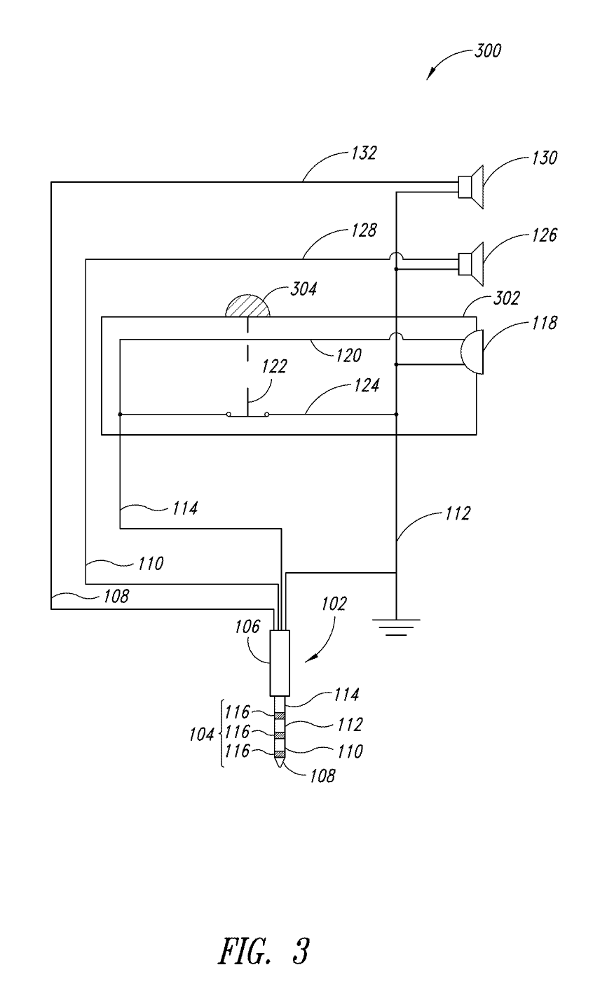

FIG. 3 depicts a tip-ring-ring-sleeve connector 102 coupled to a microphone 118, a push-to-talk switch 122, a first speaker 126 and a second speaker 130. The microphone 118, the microphone circuit 120, the push-to-talk switch 122 and the push-to-talk circuit 124 are at least partially disposed within a housing 302. The push-to-talk switch 122 can be selectively toggled between the first state and the second state using an actuator 304 disposed at least partially on or about an exterior surface of the housing 302. In at least some embodiments, the first speaker 126, the second speaker 130, and the housing 302 including the microphone 118 and the push-to-talk switch 122 can form at least a portion of the headset 300.

The housing 302 can include, in whole or in part, the microphone circuit 120 and the push-to-talk circuit 124. In some instances, the actuator 304 can be a discrete device such as a button or similar protrusion or detent on the surface of the housing 302. In other instances, the actuator 304 can include a displaceable portion of the housing 302, for example a portion of the housing 302 that is rotatable about at least one axis of rotation relative to the remaining portion of the housing 302. In some embodiments, the actuator 304 may be an electrical or electromechanical device or sensor such as a capacitive or resistive sensing element.

In some embodiments, the first speaker 126 and the second speaker 130 and the housing 302 can be physically linked by a cable containing one or more electrical conductors such as the first speaker circuit 128, the second speaker circuit 132 and the microphone circuit 120. The use of a flexible cable to link the first speaker 126, second speaker 130 and the microphone 118 can facilitate the placement of the first and second speakers 126, 130 proximate a user's ears and the placement of the microphone 118 proximate a user's mouth. Disposing both the push-to-talk switch 122 and the microphone 118 within the housing 302 provides an intuitive push-to-talk headset 300 where the user enters and exits push-to-talk mode by manipulating the push-to-talk switch actuator 304 on the housing 302.

In some embodiments the mechanical lock 150 (not shown in FIG. 3) can be disposed in, on, or about the housing 302 to maintain the push-to-talk switch 124 in the second state (i.e. to maintain the push-to-talk headset 300 in push-to-talk mode while the mechanical lock is engaged). Alternatively, the maintained contact switch 140 (also not shown in FIG. 3) may be disposed in, on, or about the housing 302 to open the push-to-talk circuit 124 to eliminate the push-to-talk functionality of the headset 300 when the maintained contact switch 140 is opened and restore the push-to-talk functionality of the headset 300 when closed. Such maintained contact switches 140 and mechanical locks 150 can be useful, for example, in a first responder situation where emergency personnel require both hands to provide the emergency response.

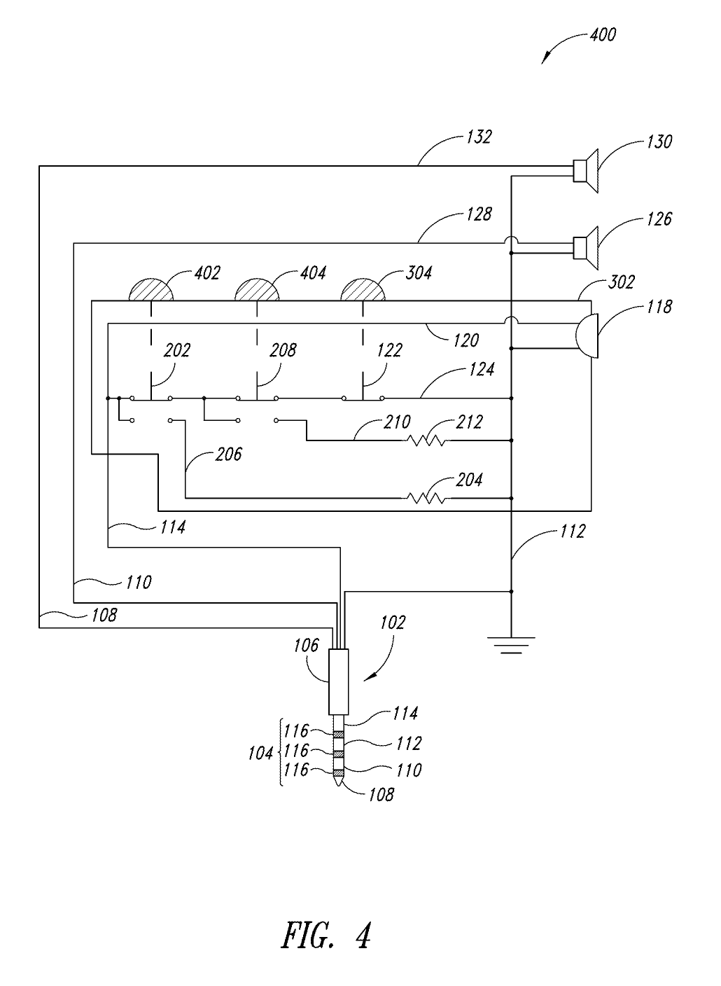

FIG. 4 depicts a tip-ring-ring-sleeve connector 102 coupled to a microphone 118, a push-to-talk switch 122, a first speaker 126 and a second speaker 130. The microphone 118, the microphone circuit 120, the push-to-talk circuit 124, the push-to-talk switch 122, the first switch 202, the first circuit 206, the second switch 208, and the second circuit 210 are at least partially disposed within a housing 402. The push-to-talk switch 122 can be selectively operably placed in the first state and the second state using an actuator 304 disposed at least partially on or about an exterior surface of the housing 302. The first switch 202 can be selectively operably placed in at least the first state and the second state using an actuator 402 disposed at least partially on or about the exterior surface of the housing 302. Similarly, the second switch 208 can be selectively displaced between at least the first state and the second state using an actuator 402 disposed at least partially on or about the exterior surface of the housing 302.

As discussed above in detail with respect to FIG. 2, the first switch 202 and the second switch 208 are electrically coupled in series with the push-to-talk switch 122 to provide the push-to-talk circuit 124 around the microphone circuit 120 when all three switches are in the respective first (i.e., closed) state. Operable placement of the push-to-talk switch 124 from the first state to the second (i.e., open) state places the headset 400 in push-to-talk mode for the duration that the push-to-talk switch 124 is maintained in the second state by the user.

Operable placement of the first switch 202 to the second state opens the push-to-talk circuit 124 and places the first resistor 204 in parallel with the microphone circuit 120. Paralleling the first resistor 204 with the microphone 118 can provide an indication to an attached electronic device that the first switch 202 has been placed in the second state by the user. Placing the first switch 202 in the second state can cause the operating system or software executing on an electronic device coupled via the tip-ring-ring-sleeve connector 102 to perform one or more predetermined or preselected functions.

In at least some embodiments, additional functionality can be obtained when the operating system or software executing on the electronic device can determine the duration the first switch 202 remains in the second state. For example, operably placing the first switch 202 in the second state for a “short” duration may sequentially step upward through a series of predetermined or preselected communications channels, while operably placing the first switch 202 in the second state for a “long” duration may immediately step to a predetermined or preselected “emergency” communication channel.

Operable placement of the second switch 208 in the second state opens the push-to-talk circuit 124 and places the second resistor 212 in parallel with the microphone circuit 120. Paralleling the second resistor 212 with the microphone 118 provides an indication to an attached electronic device that the second switch 208 has been placed in the second state by the user. Placing the second switch 208 in the second state can cause the operating system or software executed by an electronic device coupled via the tip-ring-ring-sleeve connector 102 to perform one or more predetermined or preselected functions.

In at least some embodiments, additional functionality can be obtained when the operating system or software executing on the electronic device can determine the duration the second switch 208 remains in the second state. For example, operably displacing the second switch 208 in the second state for a “short” duration may sequentially step downward through a series of predetermined or preselected communications channels, while operably placing the second switch 208 in the second state for a “long” duration may immediately generate an emergency message on a preselected “emergency” communication channel.

Although described in the context of portable electronic devices, the systems, apparatus and methods described herein are not limited to portable electronic devices and are equally applicable to any headset system using any size tip-ring-ring-sleeve connector. Example, non-limiting headset systems include, aviation headset systems, gaming headset systems, commercial headset systems, first responder and emergency services headset systems, military headset systems, broadcast headset systems, and the like.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An audio device, comprising:
a connector including a tip, a first ring, a second ring, and a sleeve, the tip, the first ring, the second ring, and the sleeve are each electrically conductive and electrically isolated from one another;
a microphone electrically coupled between the sleeve and the second ring; and
a push-to-talk switch electrically coupled between the sleeve and the second ring, the push-to-talk switch selectively operable to provide a low impedance electrical connection across the microphone in a first state and to remove the low impedance electrical connection from across the microphone in a second state.

2. The device of claim 1, further comprising:
a first speaker electrically coupled between the tip and the second ring; and
a second speaker electrically coupled between the first ring and the second ring.

3. The device of claim 2 wherein the first and the second speakers are part of a headset.

4. The device of claim 1 wherein the push-to-talk switch includes at least one set of momentary, normally closed, contacts.

5. The device of claim 1 wherein the push-to-talk switch is biased to the first state.

6. The device of claim 1, further comprising:
a mechanical lock selectively operable to retain the push-to-talk switch in the second state.

7. The device of claim 1, further comprising:
a first adjustment mechanism including a first switch and a first resistor having a first resistance, the first switch having at least a first state and a second state and selectively operable to remove the low impedance electrical connection across the microphone via the first resistor in the second state of the first switch.

8. The device of claim 7, further comprising:
a second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch.

9. The device of claim 8 wherein, when in the respective first states, the first and the second switches provide the low impedance electrical connection across the microphone along with the push-to-talk switch.

10. The device of claim 9 wherein the first and the second switches are biased to the first state.

11. The device of claim 1 wherein the connector comprises either a 3.5 mm diameter tip-ring-ring-sleeve connector or a 2.5 mm diameter tip-ring-ring-sleeve connector.

12. The device of claim 1, further comprising a switch to open the low impedance electrical connection across the microphone when the push-to-talk switch is in the first state.

13. The device of claim 1 wherein the low impedance electrical connection comprises an electrical short circuit.

14. An audio device, comprising:
a connector including a tip, a first ring, a second ring, and a sleeve, the tip, the first ring, the second ring, and the sleeve are each electrically conductive and electrically isolated from one another;
a first speaker electrically coupled between the tip and the second ring;
a second speaker electrically coupled between the first ring and the second ring;
a housing at least partially enclosing a microphone electrically coupled between the sleeve and the second ring and at least partially enclosing a push-to-talk switch electrically coupled between the sleeve and the second ring; the push-to-talk switch selectively operable to provide a low impedance electrical connection across the microphone in a first state and to remove the low impedance electrical connection from across the microphone in a second state.

15. The device of claim 14 wherein the push-to-talk switch is biased to the first state.

16. The device of claim 14, further comprising:
a mechanical lock proximate the housing, the mechanical lock selectively operable to retain the push-to-talk switch in the second state.

17. The device of claim 14, further comprising:
a first adjustment mechanism disposed at least partially within the housing, the first adjustment mechanism including a first switch and a first resistor having a first resistance, the first switch having at least a first state and a second state and selectively operable to remove the electrical short across the microphone via the first resistor in the second state of the first switch.

18. The device of claim 17, further comprising:
a second adjustment mechanism disposed at least partially within the housing, the second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch.

19. The device of claim 18 wherein, when in the respective first states, the first and the second switches provide the electrical short across the microphone along with the push-to-talk switch.

20. The device of claim 14 wherein the low impedance electrical connection comprises an electrical short circuit.

21. The device of claim 14, further comprising:
an electronic device executing at least one machine executable instruction set to convert an audio input provided to the microphone to a wireless output signal;
wherein without modifying the at least one machine executable instruction set, the audio input provided to the microphone is only included in the wireless output signal when the push-to-talk switch is in the second position.

22. The device of claim 14 wherein without modifying the at least one machine executable instruction set, the audio input provided to the microphone is not included in the wireless output signal when the push-to-talk switch is in the first position.

23. An audio method, comprising:
coupling a microphone between a sleeve and a second ring of a tip-ring-ring-sleeve connector to provide an audio input circuit; and
coupling push-to-talk switch between the sleeve and the second ring, the push-to-talk switch selectively operable to provide a low impedance electrical connection across the microphone in a first state and to remove the low impedance electrical connection from across the microphone in a second state.

24. The method of claim 23, further comprising:
coupling a first adjustment mechanism around the push-to-talk switch, the first adjustment mechanism including a first switch and a first resistor having a first resistance, the first switch having at least a first state and a second state and selectively operable to remove the low impedance electrical connection across the microphone via the first resistor in the second state of the first switch; and
coupling a second adjustment mechanism around the push-to-talk switch, the second adjustment mechanism including a second switch and a second resistor having a second resistance, the second resistance different from the first resistance, the second switch having at least a first state and a second state and selectively operable to remove the low impedance electrical connection across the microphone via the second resistor in the second state of the second switch.
